(19) United States
(12) Patent Application Publication
(10) Pub. No.: US 2015/0101323 A1
(43) Pub. Date: Apr. 16, 2015

(54) USING GRAVITY AND PIEZOELECTRIC ELEMENTS TO PRODUCE ELECTRIC POWER

(71) Applicant: Edwin Newman, Palmdale, CA (US)

(72) Inventor: Edwin Newman, Palmdale, CA (US)

(21) Appl. No.: 14/053,925

(22) Filed: Oct. 15, 2013

(51) Int. Cl. F03C 1/12; F03C 1/26

(52) U.S. Cl. CPC F03C 1/12; F03C 1/26
USPC 60/398

(57) ABSTRACT

A hydroelectric power plant comprising a pipe from a water source in a mountain range which is made to open into a much larger in diameter piston cylinder at a much lower elevation. The piston therein is driven by water pressure to drive a gear train operatively connected to an electric generator on its far end. The piston is made to move slowly under great force, while the generator is made to turn at a much greater velocity, producing electricity. Water pressure may be derived from some municipal water systems. Much less water is expended through the device than by using a turbine, as in U.S. Pat. No. 1,774,603. Instead of a piston, piezoelectric elements may be used with shut-off valves on either side of the elements. By alternating the operation of these valves intense pressure waves may be induced to produce electricity. This obviates the need for turbines and generators for hydroelectric power generation.

This invention is a development of information in Provisional Application 61/854,118.

### BACKGROUND OF THE INVENTION

Jackson., in U.S. Pat. No. 1,774,603, teaches that a turbine-operated generator may receive its operating fluid from a city's water supply system. In a modem version, Toto Corp. has been assigned the rights to U.S. Patent Application 2009/0026768. Because a turbine has been used, very little power can be generated for each cubic inch of water flowing through the turbine per second unless the cross-sectional area of the turbine is increased to a prohibitive degree. Another explanation is that since the potential energy of the water is converted into kinetic energy hydraulically a great deal of water is needed to operate a turbine. Labriola et al. (U.S. Pat. No. 2,652,690) teaches a structure which will recycle the water flowing through the turbine but the recycling operation consumes energy.

It would be advantageous to increase the amount of electrical power produced per cubic inch of water spent by a Utility's water supply per second. This is accomplished by mainly converting the potential energy of the water into kinetic energy by using mechanical, rather than hydraulic means, thereby lessening the volume of water needed to convert the potential energy of the water into the kinetic energy needed to operate an electrical generator.

Piezoelectric material can convert waves of pressure energy into electric energy. The amount of energy converted is directly dependant on the amplitude and frequency of the wave. Some thought has been given to convert ocean wave energy into electrical energy using piezoelectric elements, but the amplitude and frequency of the wave action is so low as to make this avenue of conversion impractical. A hydroelectric solution is called for.

### SUMMARY OF THE INVENTION

### First Preferred Embodiment

Instead of a turbine, a piston driven by water pressure from a Utility's water supply is used. Affixed to the piston is a shaft supporting a gear rack which is operatively connected to a long gear train which in its turn is made to operate an electrical generator which is made to supply electric power to the electric grid.

Another piston is provided to be made to drive the gear rack in the opposite direction when the gear rack and first piston have reached the end of its travel. The exhausted water may be used for irrigation or expended into the sewer system. One may find in a general way this arrangement in U.S. Pat. No. 2,215,157. But there Temperature change is critical to supplying the energy needed to operate the invention.

Residential water pressure in Palmdale, California is about 70 psi. This translates into about 164 ft. of elevation head. Palmdale is 2500 ft. above sea level while Lake Oroville, from where some of the water supply comes from is 300 ft. above sea level. Another source of water is from wells. The water needs to be pumped uphill and while the extra volume from this attached invention is not great, it is a further load on the pumps. On a large scale the picture is different. Large hydroelectric stations embodying this invention could be situated along the coast at about 10-20 ft. above sea level. Water from the Sierra Mountain Range would be piped into these stations. Lake Crowley, for example, has a surface elevation of 6781 ft. above sea level. The city of Fresno is only about 80 miles away and its elevation is 308 ft. above sea level. The Pacific Ocean is about 180 miles from Lake Crowley with several mountain ranges in between. But the siphon effect within the transporting pipe means that no pumping of water uphill is needed. And this difference in elevation will insure a greater system efficiency. Since the elevation difference is so great pipe friction losses would be minimal. Further, a pipe from Lake Crowley to Palmdale could also provide electricity to the city. In both Fresno and Palmdale a parallel plumbing system could supply electricity to individual houses. By the use of Reverse Metering the electricit y supplied by the invention can be returned to the Grid which in turn would supply A.C. electrical power to individual customers.

### Second Preferred Embodiment

Instead of a piston, gear train and electric generator at the bottom of the above mentioned pipe there is a chamber full of water and containing piezoelectric material connected to the power grid. There is an outlet pipe containing a shut-off valve and the above mentioned transport pipe connected to the chamber which also contains a shut-off valve. Opening and closing these valves alternately produces waves of pressure on the piezoelectric elements, producing electricity. The aim of this embodiment of the invention is to greatly increase the amplitude and frequency of the pressure waves impacting piezoelectric material so as to greatly enhance the possible electric output of piezoelectric elements and eliminate the need for turbines and generators in electric power production. For current research on increasing the fatigue limits of ceramic piezoelectric materials the user is referred to U.S. Patent Application 20130153812.

### BRIEF DESCRIPTION OF THE DRAWINGS

FIG. 1 shows the various parts of the First Preferred Embodiment interconnected, bur without support structure.

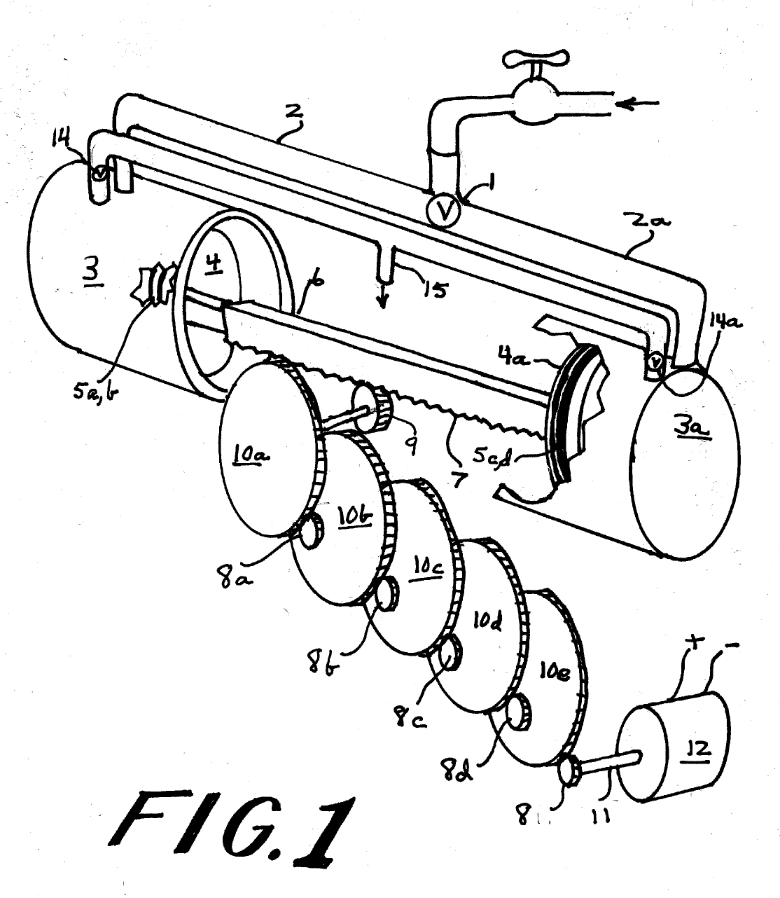

FIG. 2 shows the various parts of the Second Preferred Embodiment concerning ceramic piezoelectric material interconnected, but without support structure. FIG. 3 shows the various parts of the Second Preferred Embodiment concerning plastic piezoelectric material interconnected but without support structure.

### DETAILED DESCRIPTION OF THE FIRST PREFERRED EMBODIMENT

Pressurized water is made to move through valve 1 and either move through pipe 2 or 2a. This action forces either piston 4 or 4a to move shaft 6 to which gear rack 7 is fixedly attached. O-rings 5a-d seal the pistons for effective operation. Gear rack 7 is built to mesh with gear 9 which is shafted to rotate large spur gear 10a. which in turn is made to rotate a smaller spur gear 8a. Spur gear 8e is made to operate generator 12 through the agency of shaft 11 at a greater speed than the speed at which pistons 4,4a are made to move by the pressurized water.

In operation, as piston 4 comes to the end of its travel valve 1 is moved to cut off pressure to the back of piston 4 and introduce pressure to the back of piston 4a. This action causes check valve 14 to open and non-pressurized water from piston cylinder 3 to be evacuated through pipe 15 and be exhausted.

More pairs of spur gears used means that less water is exhausted and generator 12 is operated at a higher speed. Pistons 4,4a should be made large enough in diameter so mechanical and electrical friction are overcome.

In the prototype one cubic foot of water generates_watts.

### Detailed Description of the Second Preferred Embodiment

There are two types of piezoelectric material: ceramic, which converts pressure waves by being compressed, and plastic, which converts pressure waves by being stretched. Each require different structures.

a. Ceramic Piezoelectric Material.

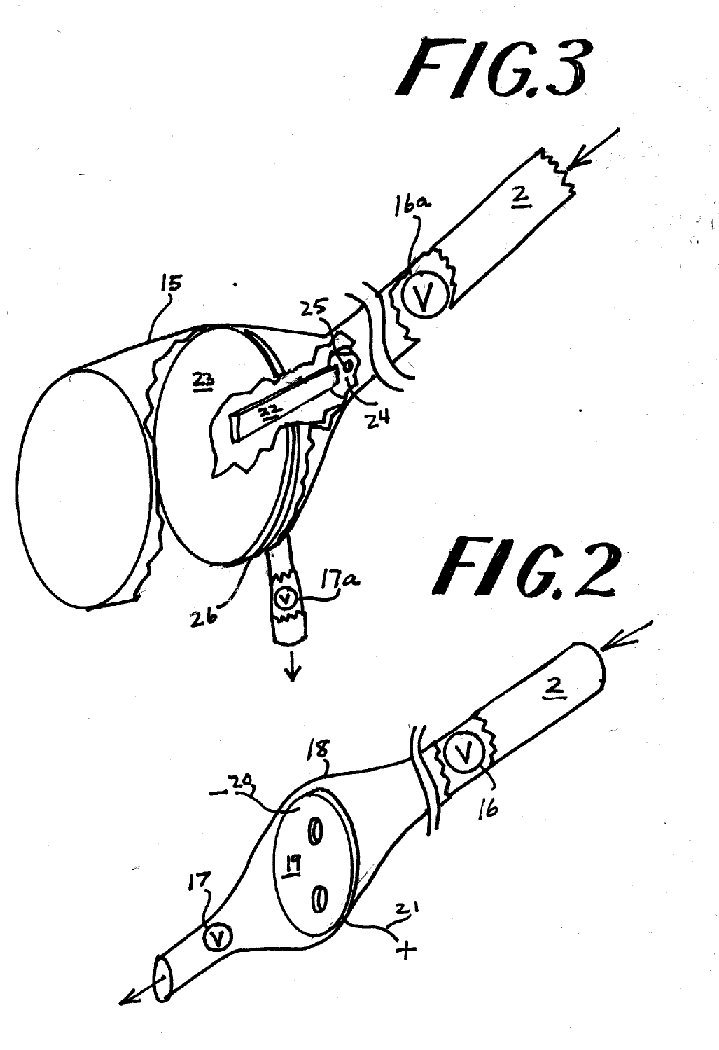

Referring to FIG. 2, we see pipe 2 containing shut-off valve 16 which is at a distance from chamber 18 and shut-off valve 17 within pipe 2 at the distal end of chamber 18. Lining chamber 18 are a number of ceramic piezoelectric elements 19 connected to wires 20,21 which are made to carry electrical output from the elements 19 to the power grid.

In operation, pipe 2 and chamber 18 to valve 17 are full of water. Valve 16 is opened which causes a pressure wave to fill chamber 18 and press on piezoelectric elements 19, producing electricity. The pressure wave strikes valve 17. Then valve 16 is shut and valve 17 is opened which causes the water pressure in chamber 18 to drop to zero with some of the water exhausted through valve 17. This cycle is repeated according to the angular frequency desired.

b. Plastic Piezoelectric Material.

Referring to FIG. 3, we see transport pipe 2 and valve 16a which is at a distance from chamber 15. Valve 17a also is made to open into chamber 26. Within chamber 26 is abutment 24 fixedly attached to the walls of chamber 26 with holes 25 in it and to which one end of plastic piezoelectric element 22 is fixedly attached. To the distal end of plastic piezoelectric element a piston 23 with O-ring 26 is fixedly attached.

In operation, Pipe 2 and chamber 26 to valve 17a and piston 23 are full of water. Valve 16a is opened

I claim:

1. A hydroelectric power plant comprising:
a. a water source at a high elevation,
b. a pipe means operatively connected to said water source at a first end and filled with water,
c. a faucet means operatively connected to said pipe means second end at a lower elevation,
d. a piston means,
e. a gear train means arranged to increase the angular velocity of its final element, and
f. a generator means, all operatively connected so pressurized water made to enter through said faucet means is made to drive said piston means, said gear train means, and said generator means so electric power is produced.

2. The gear train means of claim 1 wherein a large and small gear means is mounted on a single axle.

3. The gear train means of claim 1 wherein said gear train comprises spur gears.

4. The piston means of claim 1 wherein said piston within a piston is within a cylinder sleeve and sealed with O-rings.

5. A hydroelectric power plant comprising:
a. a water source at a high elevation,
b. a pipe means operatively connected to said water source at a first end and filled with water,
c. a chamber operatively connected to said pipe's second end at a lower elevation and filled with water,
d. a first valve means located in said pipe means,
e. a second valve means operatively connecting said chamber and the atmosphere, and
f. a piezoelectric means located within said chamber and operatively connected to a power grid so pressurized water made to enter said chamber through said first valve means will be made to operate said piezoelectric means and said water being made to exit said chamber through said second valve means will also be made to operate said piezoelectric means.

6. The hydroelectric power plant of claim 5 wherein said piezoelectric means is operated by compressing said piezoelectric means.

7. The hydroelectric power plant of claim 5 wherein said piezoelectric means is operated by stretching said piezoelectric means and ind is fixedly attached to an abutment on a first end and a piston means on a second and distal end so as said water is pressurized said piston will be made to move and stretch said piezoelectric means.
